(19) United States
(12) Patent Application Publication
(10) Pub. No.: US 2025/0301439 A1
(43) Pub. Date: Sep. 25, 2025

(54) VEHICLE-MOUNTED APPARATUS AND CONTROL METHOD

(71) Applicant: Panasonic Automotive Systems Co., Ltd., Kanagawa (JP)

(72) Inventor: Akito SAKAMOTO, Kanagawa (JP)

(73) Assignee: Panasonic Automotive Systems Co., Ltd., Kanagawa (JP)

(21) Appl. No.: 19/081,804

(22) Filed: Mar. 17, 2025

(30) Foreign Application Priority Data
Mar. 21, 2024 (JP) 2024-044908

(51) Int. Cl. H04W 64/00; H04W 4/40; H04W 72/0453; H04W 84/06

(52) U.S. Cl. CPC H04W 64/00; H04W 4/40; H04W 72/0453; H04W 84/06

(57) ABSTRACT

In a vehicle-mounted apparatus, first position information on a vehicle measured based on a signal from a GNSS satellite is acquired. A control unit causes a communication unit to use a communication setting of the first area in an event that the first position information is distanced, in the first area, from a boundary between the first area and the second area by a predetermined threshold or larger. In an event that the first position information reaches a distance to the boundary smaller than the threshold value, the control unit causes the communication unit to use the communication setting of the second area provided that a position relationship between i) second position information on the vehicle derived based on vehicle peripheral information acquired by a sensor mounted on the vehicle and ii) the boundary meets a predetermined criterion.

### BACKGROUND

### 1. Field

The present disclosure relates to a vehicle-mounted apparatus and a control method.

### 2. Description of the Related Art

A vehicle-mounted apparatus capable of performing communication by wireless LAN (Local Area Network) is known (see, for example, Patent Literature 1). This vehicle-mounted apparatus acquires vehicle position information by using GNSS (Global Navigation Satellite System), etc. Further, the vehicle-mounted apparatus stores information on the location of each country. Using these items of information, the vehicle-mounted apparatus switches wireless LAN in the 5 GHz band to wireless LAN in the 2.4 GHz band when the vehicle is close to a border. After crossing the border and entering the next country, the vehicle-mounted apparatus switches from wireless LAN in the 2.4 GHz band to wireless LAN in the 5 GHz band. In this process, the frequency channel of the 5 GHz band of the next country is used.

[Patent Literature 1] JP 2020-141158

### SUMMARY

Further improvements are called for in vehicle-mounted apparatuses.

A vehicle-mounted apparatus according to an embodiment of the present disclosure is a vehicle-mounted apparatus mounted on a vehicle, including: a communication unit that is adapted to communication in one of a plurality of frequency channels; a storage unit that stores information on a communication setting of each of a plurality of areas, the communication setting of each area including information on the frequency channel adapted to be used by the communication unit in the area; an acquisition unit that acquires first position information on the vehicle measured based on a signal from a GNSS satellite; and a control unit that, in a case the first position information acquired by the acquisition unit changes from a first area to a second area, causes the communication unit to use the communication setting of the first area based on the information stored in the storage unit in an event that the first position information is distanced, in the first area, from a boundary between the first area and the second area by a predetermined threshold or larger. In an event that the first position information reaches a distance to the boundary smaller than the threshold value, the control unit causes the communication unit to use the communication setting of the second area based on the information stored in the storage unit provided that a position relationship between i) second position information on the vehicle derived based on vehicle peripheral information acquired by a sensor mounted on the vehicle and ii) the boundary meets a predetermined criterion.

Another embodiment of the present disclosure relates to a control method. The method is a control method in a vehicle-mounted apparatus mounted on a vehicle, the vehicle-mounted apparatus including a communication unit that is adapted to communication in one of a plurality of frequency channels, and a storage unit that stores information on a communication setting of each of a plurality of areas, the communication setting of each area including information on the frequency channel adapted to be used by the communication unit in the area. The method includes: acquiring first position information on the vehicle measured based on a signal from a GNSS satellite; in a case the first position information acquired by the acquiring changes from a first area to a second area, causing the communication unit to use the communication setting of the first area based on the information stored in the storage unit, when the first position information is distanced, in the first area, from a boundary between the first area and the second area by a predetermined threshold or larger; and in an event that the first position information reaches a distance to the boundary smaller than the threshold value, causing the communication unit to use the communication setting of the second area based on the information stored in the storage unit provided that a position relationship between i) second position information on the vehicle derived based on vehicle peripheral information acquired by a sensor mounted on the vehicle and ii) the boundary meets a predetermined criterion.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a functional configuration of a wireless system of the embodiment;

FIG. 2 shows a data structure of the table stored in the third storage unit;

FIG. 3 shows the frequency band available in the first and second countries and the timing to change the communication setting;

FIG. 4 illustrates switching control of the communication setting according to the movement of the vehicle;

FIG. 5 is a flowchart showing a first exemplary process performed by the vehicle-mounted apparatus of FIG. 1;

FIG. 6 shows another example of the frequency band available in the first and second countries and the timing of changing the communication setting;

FIG. 7 is a flowchart showing a second exemplary process performed by the vehicle-mounted apparatus of FIG. 1; and

FIG. 8 shows another exemplary configuration of the wireless system of the embodiment.

### DETAILED DESCRIPTION

The invention will now be described by reference to the preferred embodiments. This does not intend to limit the scope of the present invention, but to exemplify the invention.

Before giving a specific description of embodiments, the base findings of the present disclosure will be described. In wireless LAN, a plurality of frequency channels are provided in each of the 5 GHz band and the 2.4 GHz band. Further, the frequency channels that can be used outdoors are defined individually in each country. Outdoors include the vehicle cabin. In some countries, the use of the 5 GHz band is prohibited. Even in a neighboring country, therefore, the available frequency channels may be different from those of the country of current position.

When a vehicle equipped with a wireless LAN vehicle-mounted apparatus crosses the border to move from the first country to the next, the use of the frequency channel used in the first country must be stopped before crossing the border if the frequency channel cannot be used in the next country. To achieve this, there is a technology that uses GNSS to acquire the position information on the vehicle, identifies the country where the vehicle is located and the neighboring country based on the position information, determines whether the vehicle has crossed the border, and switches the frequency channel used according to the determination result.

In GNSS positioning, however, reception of radio waves from a GNSS satellite may deteriorate and the positioning accuracy may drop when the vehicle is traveling near buildings, in tunnels, under overpasses, in mountainous areas, etc., or when the reception is affected by bad weather or interference from communication equipment. According to the above-mentioned technology, therefore, the frequency channel may be switched at an inappropriate position in a situation where the GNSS positioning accuracy is low. This may result in using a frequency channel that is prohibited in the country where the vehicle is traveling. In that case, the user may be regarded as having violated the radio regulation.

On the other hand, a technology is also conceivable whereby a plurality of neighboring countries are grouped from the viewpoint of radio regulation and communication is restricted to frequency channels that can be used in common among a plurality of countries grouped. For example, the frequency channel is limited so that the 5 GHz band is not used. However, this technology reduces the convenience of the user because the number of available frequency channels is reduced.

To solve these problems, the vehicle-mounted apparatus according to the present disclosure is configured as follows.

Hereinafter, identical or like constituting elements, members, steps shown in the drawings are represented by identical symbols, and a duplicate description will be omitted as appropriate. The dimension of the members in the drawings shall be enlarged or reduced as appropriate to facilitate understanding.

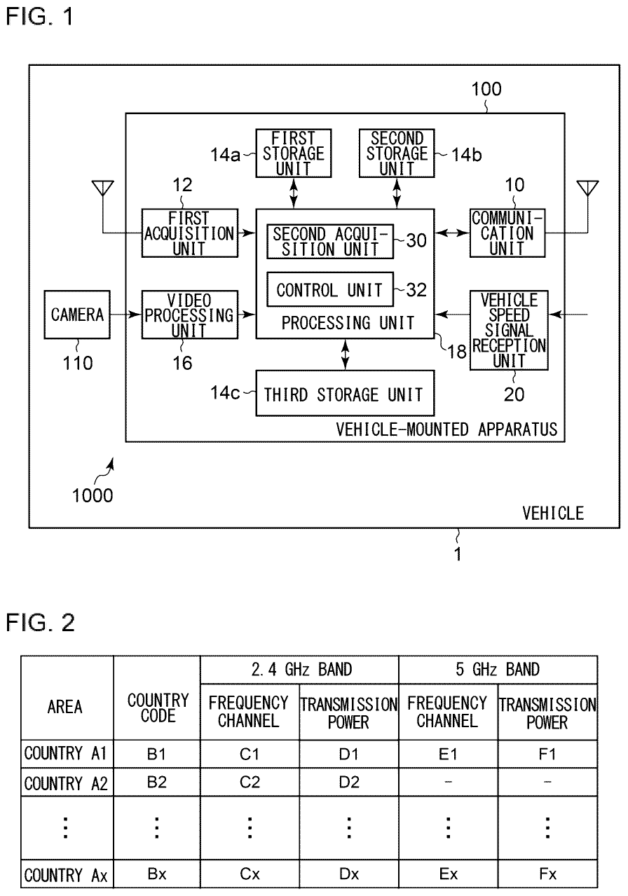

FIG. 1 shows a functional configuration of a wireless system 1000 of the embodiment. The wireless system 1000 is mounted on a vehicle 1. The wireless system 1000 includes a vehicle-mounted apparatus 100 and a camera 110. The vehicle-mounted apparatus 100 can also be referred to as a wireless apparatus. The vehicle-mounted apparatus 100 may be connected to an electronic appliance such as a navigation system (not shown) with a cable etc. or may be built in the electronic appliance. The vehicle-mounted apparatus 100 has the function of a wireless LAN access point and can communicate with a terminal apparatus (not shown) by wireless LAN. The terminal apparatus is a smartphone, a mobile phone, etc. and is carried by the occupant of the vehicle 1. With such a configuration, the terminal apparatus and the electronic appliance can communicate with each other via the vehicle-mounted apparatus 100. When the occupant uses the terminal apparatus, thus, the electronic appliance operates according to the user operation. The vehicle-mounted apparatus 100 and the terminal apparatus may have a wireless communication function other than wireless LAN, but a description of a wireless communication function other than wireless LAN will be omitted here.

The vehicle-mounted apparatus 100 includes a communication unit 10, a first acquisition unit 12, a first storage unit 14a, a second storage unit 14b, a third storage unit 14c, a video processing unit 16, a processing unit 18, and a vehicle speed signal reception unit 20.

The processing unit 18 includes a second acquisition unit 30 and a control unit 32. The features of the processing unit 18 can be implemented in hardware such as a CPU (Central Processing Unit), a memory, or other LSI's (Large Scale Integration), of any computer and in software such as a program loaded into a memory. The figure depicts functional blocks implemented by the cooperation of these elements. Therefore, it will be understood by those skilled in the art that the functional blocks may be implemented in a variety of manners by hardware only or by a combination of hardware and software.

The communication unit 10 has the function of a wireless LAN access point and performs communication by wireless LAN. The communication unit 10 can perform communication in the first frequency band (e.g., the 2.4 GHz band) and can also perform communication in the second frequency band (e.g., the 5 GHz band).

As described above, a plurality of frequency channels are provided in the 5 GHz band. Specifically, the 5 GHz band is divided into the 5.2 GHz band, the 5.3 GHz band, the 5.6 GHz band, and the 5.8 GHz band. Further, four frequency channels 36ch, 40ch, 44ch, and 48ch are provided in the 5.2 GHz band, and four frequency channels: 52ch, 56ch, 60ch, and 64ch are provided in the 5.3 GHz band. The 5. 6 GHz band is provided with 11 frequency channels: 100ch, 104ch, 108ch, 112ch, 116ch, 120ch, 124ch, 128ch, 132ch, 136ch, and 140ch. The 5.8 GHz band is provided with four frequency channels: 149ch, 153ch, 157ch, and 161ch. Further, among these plurality of frequency channels, the frequency channels that can be used are stipulated in each country. As mentioned above, there are countries where not all frequency channels in the 5 GHz band can be used. When using the 5 GHz band, the communication unit 10 communicates with the terminal apparatus by using one of the plurality of available frequency channels.

As described above, a plurality of frequency channels are provided in the 2.4 GHz band as well. Specifically, 13 frequency channels from 1ch through 13ch are provided in the 2.4 GHz band. Further, among these plurality of frequency channels, the frequency channels that can be used are stipulated in each country. Unlike the 5 GHz band, the 2.4 GHz band can be used in all countries. When using the 2.4 GHz band, the communication unit 10 communicates with the terminal apparatus by using one of the plurality of available frequency channels. Control on the communication unit 10 is performed by the control unit 32.

The first acquisition unit 12 receives a signal from a GNSS satellite, and based on the received signal, measures the position information, the orientation information, etc. on the vehicle 1 and acquires the position information, etc. thus measured. The first acquisition unit 12 can also be called a GNSS receiver. The position information is indicated by latitude and longitude. The orientation information is indicated by the azimuth angle and represents the direction of travel of the vehicle 1. The first acquisition unit 12 outputs the acquired position information, etc. to the processing unit 18.

The first storage unit 14a stores two-dimensional map information showing area information on each country.

The area information is information that indicates the range of the location of each country. That is, the first storage unit 14a stores map information indicating the location of each of a plurality of areas. The area is not limited to a country and may represent a predetermined region.

The second storage unit 14b stores three-dimensional map information showing the area information on each country. Hereinafter, a three-dimensional map is also referred to as a 3D map. The second storage unit 14b stores three-dimensional map information showing the location of each of the plurality of areas. A three-dimensional map is a high-precision map that contains road information for each lane, surrounding structures, signs, signals, etc., with an accuracy of about a centimeter. As will be described later, the position of the driver's vehicle can be derived more accurately by checking the image acquired by the camera 110 while the vehicle 1 is running against the three-dimensional map in real time. Since a known technology may be used in a three-dimensional map, a further explanation will be omitted.

The third storage unit 14c stores a table showing frequency channels that can be used in each country among the plurality of frequency channels in the 2.4 GHz band and the 5 GHz band. This table also shows the transmission power in the 2.4 GHz and 5 GHz bands that can be output in each country. That is, the third storage unit 14c stores information on the communication setting of each of the plurality of areas used by the communication unit 10. The communication setting of each area includes information on the frequency channel and the transmission power that can be used by the communication unit 10 in the area. The communication setting can also be called a wireless parameter or a communication condition.

FIG. 2 shows a data structure of the table stored in the third storage unit 14c. Countries are indicated as “country A1”, “country A2”, “country Ax”, etc. x denotes a predetermined natural number. It is also indicated that the country code of “country A1” is “B1”, the country code of “country A2” is “B2”, and the country code of “country Ax” is “Bx”.

With regard to the 2.4 GHz band, it is also indicated that the frequency channel “C1” can be used, and the transmission power is “D1” in “country A1”, the frequency channel “C2” can be used and the transmission power is “D2” in “country A2”, and the frequency channel “Cx” can be used and the transmission power is “Dx” in “country Ax”. The frequency channel “C1” is a generic term for one or more frequency channels that can be used in “country A1”. The frequency channel “C2”, . . . , the frequency channel “Cx” are the same as the frequency channel “C1”. The frequency channels “C1”, “C2”, etc. in the following may represent the same one or more frequency channels regardless of the difference in notation. The transmission power “D1”, “D2”, etc. may also represent the same value regardless of the difference in notation.

With regard to the 5 GHz band, it is also indicated that the frequency channel “E1” can be used, and the transmission power is “F1” in “country A1”, there are no frequency channels available in “country A2”, and the frequency channel “Ex” can be used, and the transmission power is “Fx” in “country Ax”. The frequency channel “E1” is also a generic term for one or more frequency channels that can be used in “country A1”. The frequency channel “Ex”, etc. are the same as the frequency channel “E1”. In “country A2”, for example, the use of the 5 GHz band is prohibited because there are no frequency channels available in the 5 GHz band. The frequency channels “E1”, etc. in the following may represent the same one or more frequency channels regardless of the difference in notation. The transmission power “F1” etc. may represent the same value regardless of the difference in notation. Reference is made back to FIG. 1.

The camera 110 is mounted on the vehicle 1, periodically captures an image in front of the vehicle 1 at a predetermined frame rate, and sequentially supplies the captured image data to the vehicle-mounted apparatus 100. The camera 110 may be included in, for example, an ADAS (Advanced Driver-Assistance System) not shown. ADAS can control the running gear of the vehicle 1 to perform driving assistance. The camera 110 corresponds to a sensor that acquires vehicle peripheral information, which is an image in front of the vehicle 1.

The video processing unit 16 receives the image data for a scene in front of the vehicle 1 captured by the camera 110, performs a predetermined data process, and supplies the processed image data to the processing unit 18. The video processing unit 16 starts or stops the process according to the control by the processing unit 18.

The vehicle speed signal reception unit 20 is connected to a vehicle-mounted network such as a CAN (Controller Area Network) and receives a vehicle speed signal indicating the moving speed of the vehicle 1. The vehicle speed signal reception unit 20 outputs the vehicle speed signal to the processing unit 18.

The processing unit 18 receives the first position information and the orientation information from the first acquisition unit 12, receives the image data from the video processing unit 16, and receives the vehicle speed information from the vehicle speed signal reception unit 20. The processing unit 18 controls the communication unit 10 based on the received information.

A description will be given of a process performed in the case the first position information acquired by the first acquisition unit 12 changes from the first area to the second area in the map information stored in the first storage unit 14a. Hereinafter, it will be assumed the first area is the first country and the second area is the second country.

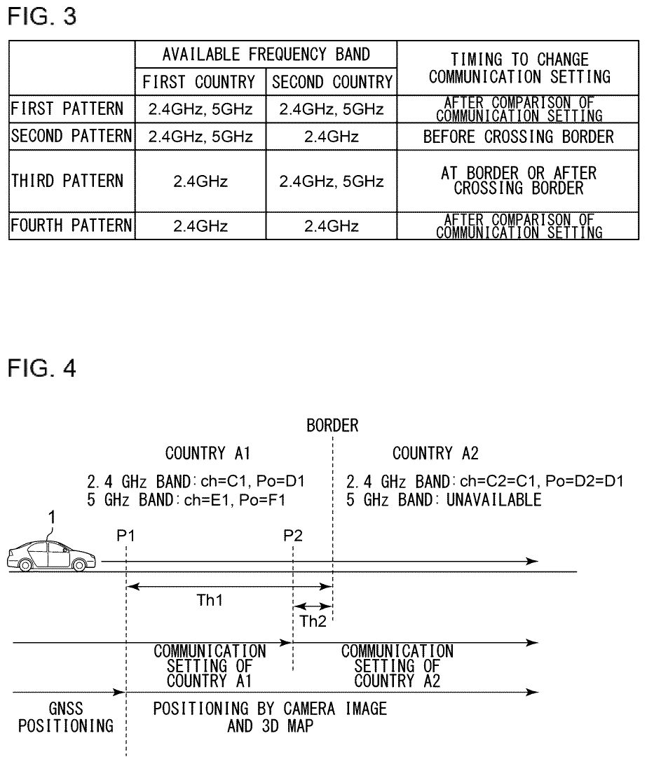

Further, a situation is assumed in which the vehicle moves among a plurality of countries that meet a condition that the available frequency channel and the transmission power in the 2.4 GHz band remain unchanged regardless of the country, and in which, among a plurality of countries where the 5 GHz band can be used, the available frequency channel and the transmission power in the 5 GHz band also remain unchanged regardless of the country. In other words, the vehicle is assumed to move in a situation where only the availability of the 5 GHz band differs depending on the country. The process in the vehicle-mounted apparatus 100 in this case is referred to as the first exemplary process. In this case, there are four patterns shown in FIG. 3 in the combination of frequency bands available in the first and second countries.

FIG. 3 shows frequency bands available in the first and second countries and the timing to change the communication setting. In the first pattern, the 2.4 GHz band and the 5 GHz band can be used in the first country, and the 2.4 GHz band and the 5 GHz band can be used also in the second country. In the second pattern, the 2.4 GHz band and the 5 GHz band can be used in the first country, and the 2.4 GHz band can be used, and the 5 GHz band cannot be used in the second country. In the third pattern, the 2.4 GHz band can be used, and the 5 GHz band cannot be used in the first country, and the 2.4 GHz band and the 5 GHz band can be used in the second country. In the fourth pattern, the 2.4 GHz band can be used, and the 5 GHz band cannot be used in the first country, and the 2.4 GHz band can be used, and the 5 GHz band cannot be used in the second country, too. The timing to change the communication setting will be described later. Reference is made back to FIG. 1.

Among the plurality of areas on the map stored in the first storage unit 14a, the control unit 32 identifies the area including the first position information acquired by the first acquisition unit 12 as the first country and identifies that the vehicle 1 is located in the first country. The control unit 32 may correct the first position information by using a known technology based on the vehicle speed signal received from the vehicle speed signal reception unit 20. Further, the control unit 32 identifies the second country to which the vehicle 1 is heading on the map stored in the first storage unit 14a, based on the orientation information acquired by the first acquisition unit 12. Hereinafter, the second country may be referred to as the neighboring country. Subsequently, the control unit 32 acquires information on the border that is the boundary between the first country and the second country from the map information stored in the first storage unit 14a. Further, the control unit 32 identifies a point on the border closest to the first position information. Hereinafter, the point will also be referred to as the border. The control unit 32 derives a distance between the first position information and the point on the border closest to the first position information. The control unit 32 stores a fixed, first threshold value in advance and compares the derived distance with the first threshold value. The first threshold is not particularly limited and may be, for example, 1 km. The first threshold can be appropriately determined by an experiment or a simulation.

When the distance to the border is equal to or larger than the first threshold value, the control unit 32 identifies the communication setting of the first country where the vehicle 1 is located, based on the information stored in the third storage unit 14c. That is, the control unit 32 identifies the frequency channel and the transmission power in the 2.4 GHz band that can be used in the first country and also identifies the frequency channel and the transmission power in the 5 GHz band provided that the 5 GHz band can also be used in the first country.

The control unit 32 instructs the communication unit 10 to use the frequency channel and the transmission power in the identified frequency band. In response to this, the communication unit 10 selects one of the frequency channels in the 2.4 GHz band when instructed to use only the 2.4 GHz band. When instructed to use the 2.4 GHz band and the 5 GHz band, the communication unit 10 selects one of the 2.4 GHz frequency band and the 5 GHz frequency band and selects one of the frequency channels in the selected frequency band. In the case a WiFi chip such as that having a Dual MAC function is mounted in the communication unit 10, the 2.4 GHz band and the 5 GHz band can be used at the same time, which is a possible case. The communication unit 10 performs communication with the terminal apparatus by using the selected frequency channel with the designated transmission power. A known technology may be used for selection of the frequency band and the frequency channel and for execution of communication with the terminal apparatus in the communication unit 10 so that a description thereof will be omitted.

These processes correspond to the control unit 32 causing the communication unit 10 to use the communication setting of the first area in the event that the first position information is distanced, in the first area, from the boundary between the first area and the second area by the first threshold value or larger.

When the distance to the border is smaller than the first threshold value, the control unit 32 instructs the video processing unit 16 to start the process and instructs the second acquisition unit 30 to acquire the second position information. The video processing unit 16 processes the image data captured by the camera 110 in response to the instruction from the control unit 32 and supplies the processed image data to the processing unit 18.

The second acquisition unit 30 receives the image data from the video processing unit 16 in response to the instruction from the control unit 32, checks the received image data against the 3D map in real time to derive the second position information and the orientation information on the vehicle 1, and supplies the second position information and the orientation information thus derived to the control unit 32. Even when the reception of radio waves from the GNSS satellite is poor, the second position information represents the current position of the vehicle 1 with high accuracy. The above process of the video processing unit 16 and the second acquisition unit 30 is repeated at the frame rate of the camera 110. Since a publicly known technology may be used to check the image data against the 3D map and derive the second position information and the orientation information, a description thereof will be omitted. This process corresponds to the second acquisition unit 30 acquiring the second position information on the vehicle 1 derived based on the vehicle peripheral information acquired by the sensor mounted on the vehicle 1.

The second acquisition unit 30 may not derive the second position information, etc. until it receives an instruction from the control unit 32. This reduces the processing load on the processing unit 18 and reduces power consumption.

The control unit 32 then identifies the area, among the plurality of areas on the three-dimensional map stored in the second storage unit 14b, that includes the second position information acquired by the second acquisition unit 30 as the first country and identifies that the vehicle 1 is located in the first country. Further, the control unit 32 identifies the second country on the three-dimensional map to which the vehicle 1 is heading, based on the orientation information acquired by the second acquisition unit 30.

Subsequently, the control unit 32 identifies the communication setting of the first country and the communication setting of the second country based on the information stored in the third storage unit 14c. The control unit 32 then makes a comparison to see whether the communication setting of the first country is the same as the communication setting of the second country.

The case in which the communication setting of the first country is the same as the communication setting of the second country corresponds to the first pattern or the fourth pattern of FIG. 3. In this case, the control unit 32 does not wait for the vehicle 1 to get closer to the border and immediately changes the communication setting of the communication unit 10 after comparing the communication settings. Specifically, the control unit 32 instructs the communication unit 10 to use the frequency channel in the frequency band and the transmission power defined in the communication setting of the second country. In response to this, the communication unit 10 selects one of the frequency channels in the 2.4 GHz band when instructed to use only the 2.4 GHz band. When instructed to use the 2.4 GHz band and the 5 GHz band, the communication unit 10 selects one of the 2.4 GHz frequency band and the 5 GHz frequency band and selects one of the frequency channels in the selected frequency band. The communication unit 10 performs communication with the terminal apparatus by using the selected frequency channel with the designated transmission power. In this case, it is not necessary to identify the position relationship between the second position information and the border so that the processing load can be reduced.

This process corresponds to the control unit 32 causing, in the case the communication setting of the first area is the same as the communication setting of the second area, the communication unit 10 to use the communication setting of the second area regardless of the position relationship between the second position information and the boundary in the event that the first position information reaches a distance from the border smaller than the first threshold value.

In the case the communication setting of the first country is different from the communication setting of the second country, on the other hand, the control unit 32 causes the communication unit 10 to use the communication setting of the second country in the event that the first position information reaches a distance from the border smaller than the first threshold value provided that the position relationship between the second position information and the border meets a predetermined criterion. The case in which the communication setting of the first country is different from the communication setting of the second country corresponds to the second pattern or the third pattern of FIG. 3. In this case, the timing to change the communication setting of the communication unit 10 is different between the second pattern and the third pattern.

In the case the communication setting of the first country is different from the communication setting of the second country, the control unit 32 acquires information on the border that is the boundary between the first country and the second country from the three-dimensional map information stored in the second storage unit 14b. Further, the control unit 32 identifies a point on the border closest to the second position information. Hereinafter, the point will also be referred to as the border. The control unit 32 derives a distance between the second position information and the point on the border closest to the second position information.

In the case the 5 GHz is added as the available frequency band in the second area as in the third pattern of FIG. 3, the control unit 32 changes the communication setting of the communication unit 10 in the event that the distance to the derived border becomes zero or in the event that the second position information is included in the second country in the three-dimensional map information stored in the second storage unit 14b. In the case the 5 GHz band is added, therefore, the control unit 32 makes an update to the communication setting of the second country when the vehicle 1 reaches the border or crosses the border. This makes it possible to reliably suppress communication being performed in the first country in the frequency channel in the 5 GHz band that cannot be used.

This process corresponds to the control unit 32 determining, in the case the communication setting of the first area includes information on the frequency channel in the first frequency band and does not include information on the frequency channel in the second frequency band, and the communication setting of the second area includes information on the frequency channel in each of the first frequency band and the second frequency band, and the frequency channel in the first frequency band in the communication setting of the first area is the same as the frequency channel in the first frequency band in the communication setting of the second area, that a predetermined criterion is met and causing the communication unit 10 to use the communication setting of the second area in the event that the second position has reached or passed the border.

Further, the control unit 32 stores a fixed,

second threshold value in advance and, in the case the 5 GHz band is deleted from the frequency band that can be used in the second area, compares the distance to the derived border and the second threshold value as shown in the second pattern of FIG. 3. When the distance to the border becomes smaller than the second threshold value, the control unit 32 changes the communication setting of the communication unit 10 and updates it to the communication setting of the second country. The second threshold value is smaller than the first threshold value. The second threshold value is not particularly limited and may be, for example, 100 m. The second threshold can be appropriately determined by an experiment or a simulation.

In this case, the 5 GHz band is not used before the vehicle 1 reaches the border. This makes it possible to reliably suppress communication being performed in the second country in the frequency channel in the 5 GHz band that cannot be used.

This process corresponds to the control unit 32 determining, in the case the communication setting of the first area includes the frequency channel in each of the first frequency band and the second frequency band, the communication setting of the second area includes the frequency channel in the first frequency band and does not include the frequency channel in the second frequency band, and the frequency channel in the first frequency band in the communication setting of the first area is the same as the frequency channel in the first frequency band of the communication setting of the second area, that a predetermined criterion is met and causing the communication unit 10 to use the communication setting of the second area in the event that the second position information reaches, in the first area, a distance from the border smaller than the second threshold value.

In the description so far, it is assumed that the first threshold value and the second threshold value are fixed values. At least one of these may be set such that the larger the moving speed of the vehicle 1 indicated in the vehicle speed signal, the larger the value. For example, the first threshold value may be given by a constant C x moving speed.

The case in which the vehicle 1 moves from country A1 to country A2 in the table shown in FIG. 2 is assumed, and exemplary control of the communication unit 10 will be described in more specific detail. The case of moving from country A1 to country A2 corresponds to the second pattern because the 5 GHz band can no longer be used in country A2.

FIG. 4 illustrates switching control of the communication setting according to the movement of the vehicle 1. FIG. 4 shows a situation in which the vehicle 1 moves from country A1 to country A2.

In the event that the first position information on the vehicle 1 is distanced in country A1 from the border by the first threshold value Th1 or larger, the vehicle-mounted apparatus 100 uses the communication settings of the country A1. Therefore, the vehicle-mounted apparatus 100 communicates with the transmission power “D1” by using one of the frequency channels “C1” in the 2.4 GHz band or communicates with the transmission power “F1” by using one of the frequency channels “E1” in the 5 GHz band. In the event that the first position information is distanced in country A1 from the border by the first threshold value Th1 or larger, the vehicle-mounted apparatus 100 performs GNSS positioning and does not perform positioning by the camera image and the 3D map.

In the event that the first position information on the vehicle 1 reaches a distance nearer the border than the position P1 of the first threshold value Th1 in country A1, the vehicle-mounted apparatus 100 performs positioning by the camera image and the 3D map to acquire the second position information.

In the event that the second position information on the vehicle 1 reaches a distance nearer the border than the position P2 of the second threshold value Th2 in country A1, the vehicle-mounted apparatus 100 uses the communication setting of country A2 instead of the communication setting of country A1. Therefore, the vehicle-mounted apparatus 100 communicates with the transmission power “D2” by using one of the frequency channels “C2” in the 2.4 GHz band. The frequency channel “C2” is the same as the frequency channel “C1”, and the transmission power “D2” is the same as the transmission power “D1”. The vehicle-mounted apparatus 100 does not use the frequency channel in the 5 GHz band, which is prohibited. Therefore, the radio regulation of country A2 is not violated.

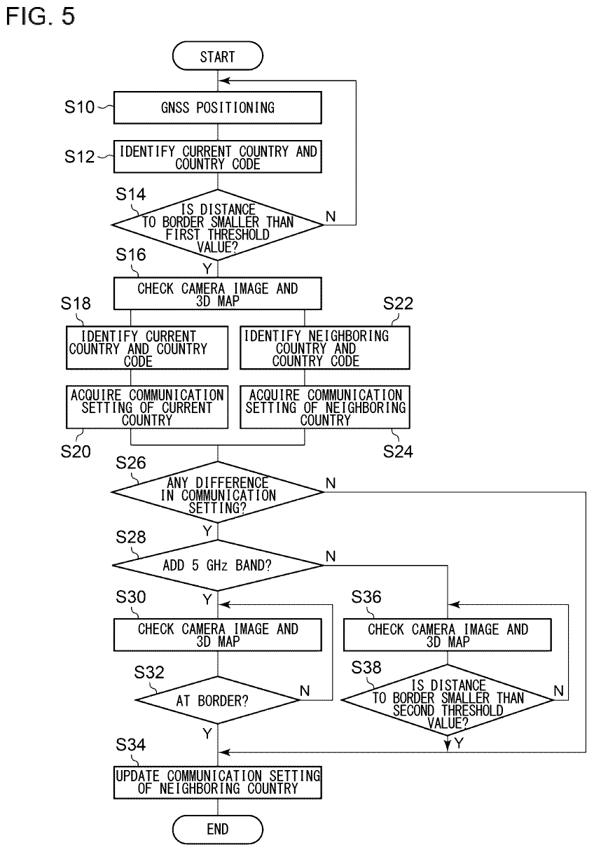

The operation of the vehicle-mounted apparatus 100 according to the above configuration will be described. FIG. 5 is a flowchart showing a first exemplary process performed by the vehicle-mounted apparatus 100 of FIG. 1. The process of FIG. 5 is performed repeatedly. The first acquisition unit 12 performs GNSS positioning (S10) and acquires the first position information. The control unit 32 identifies the current country and the country code (S12) based on the first position information and, when the distance to the border is not smaller than the first threshold value (N in S14), the process returns to S10.

When the distance to the border is smaller than the first threshold value (Y in S14), the second acquisition unit 30 checks the camera image against the 3D map (S16) to acquire the second position information, etc. The control unit 32 identifies the current country and the country code (S18) based on the second position information and acquires the communication setting of the current country (S20). In parallel with the processes of S18 and S20, the control unit 32 identifies the neighboring country and the country code (S22) based on the second position information, etc. and acquires the communication setting of the neighboring country (S24). The processes of S22 and S24 may be executed following the processes of S18 and S20.

When there is no difference between the two communication settings acquired in S20 and in S24 (N in S26), the control unit 32 updates the communication setting to be used by the communication unit 10 to the communication setting of the neighboring country (S34), and the process is terminated.

When there is a difference between the two communication settings (Y in S26), the second acquisition unit 30 checks the camera image against the 3D map (S30) to acquire the second position information in the case the 5 GHz band is added in the communication setting of the neighboring country with respect to the communication setting of the current country (Y in S28). When the second position information indicates the border (Y in S32), the process of S34 is executed. In S32, the process of S34 may be executed also when the second position information indicates that the border has been passed. If the border has not been reached (N in S32), the processing returns to S30.

In the case the 5 GHz band is not added in the communication setting of the neighboring country with respect to the communication setting of the current country (N in S28), the second acquisition unit 30 checks the camera image against the 3D map (S36) to acquire the second position information. In the case the distance to the border is determined to be smaller than the second threshold value based on the second position information (Y in S38), the process of S34 is executed. In the case the distance to the border is not smaller than the second threshold value (N in S38), the process returns to S36.

A description will now be given of a case in which the vehicle 1 moves in a situation where the available frequency channel and transmission power in each of the 2.4 GHz band and the 5 GHz band may differ depending on the country. The process in the vehicle-mounted apparatus 100 in this case is referred to as the second exemplary process. The difference from the first exemplary process described above will be mainly described below.

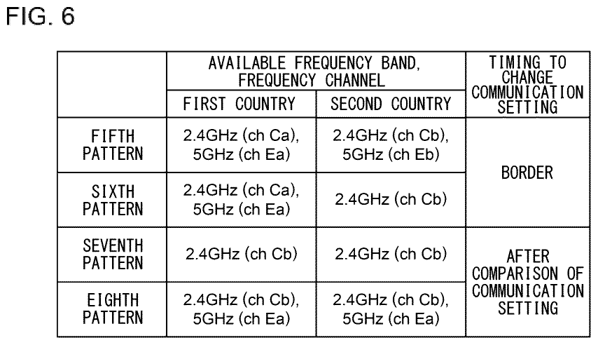

FIG. 6 shows another example of the frequency band that can be used in the first and second countries and the timing of changing the communication setting. Referring to FIG. 6, it is assumed that one or more frequency channels represented by frequency channels “Ca”, “Ea”, etc. are the same only when the notation is the same.

In the fifth pattern, the frequency channel “Ca” in the 2.4 GHz band and the frequency channel “Ea” in the 5 GHz band can be used in the first country, and the frequency channel “Cb” in the 2.4 GHz band and the frequency channel “Eb” in the 5 GHz band can be used in the second country. The frequency channel “Ca” and the frequency channel “Cb” are different. For example, the frequency channel “Ca” includes 1ch through 13ch, and the frequency channel “Cb” includes 1ch through 11ch. The frequency channel “Ea” and the frequency channel “Eb” are different. For example, the frequency channel “Ea” includes a plurality of frequency channels in the 5.2 GHz band, and the frequency channel “Eb” includes a plurality of frequency channels in the 5.8 GHz band.

In the sixth pattern, the frequency channel “Ca” in the 2.4 GHz band and the frequency channel “Ea” in the 5 GHz band can be used in the first country, and the frequency channel “Cb” in the 2.4 GHz band can be used and the 5 GHz band cannot be used in the second country.

In the seventh pattern, the frequency channel “Cb” in the 2.4 GHz band can be used and the 5 GHz band cannot be used in each of the first and second countries. In the seventh pattern, the communication setting of the first country is the same as the communication setting of the second area.

In the eighth pattern, the frequency channel “Cb” in the 2.4 GHz band and the frequency channel “Ea” in the 5 GHz band can be used in each of the first and second countries. In the eighth pattern, also, the communication setting of the first country is the same as the communication setting of the second country. In the example of FIG. 6, it is assumed that the transmission power is fixed regardless of the country. The transmission power may vary depending on the country.

In the case the communication setting of the first country is the same as the communication setting of the second country as in the seventh or eighth pattern of FIG. 6, the control unit 32 immediately changes the communication setting of the communication unit 10 after comparing the communication settings as in the first exemplary process.

In the case the communication setting of the first country is different from the communication setting of the second country as in the first or the second pattern of FIG. 6, the control unit 32 changes the communication setting of the communication unit 10 when the distance to the border derived from the second position information becomes zero. That is, the control unit 32 in this case makes an update to the communication setting of the second country when the vehicle 1 reaches the border.

This makes it possible to reliably suppress, in the case the frequency channel that cannot be used in the first country can be used in the second country, execution of communication using that frequency channel in the first country. It will also make it possible to reliably suppress, in the case the frequency channel that can be used in the first country cannot be used in the second country, execution of communication in that frequency channel in the second country.

This process corresponds to the control unit 32 determining, in the case the communication setting of the first area is different from the communication setting of the second area, that a predetermined criterion is met and causing the communication unit 10 to use the communication setting of the second area in the event that the first position information reaches a distance from the border smaller than the first threshold value provided that the second position information reaches the border.

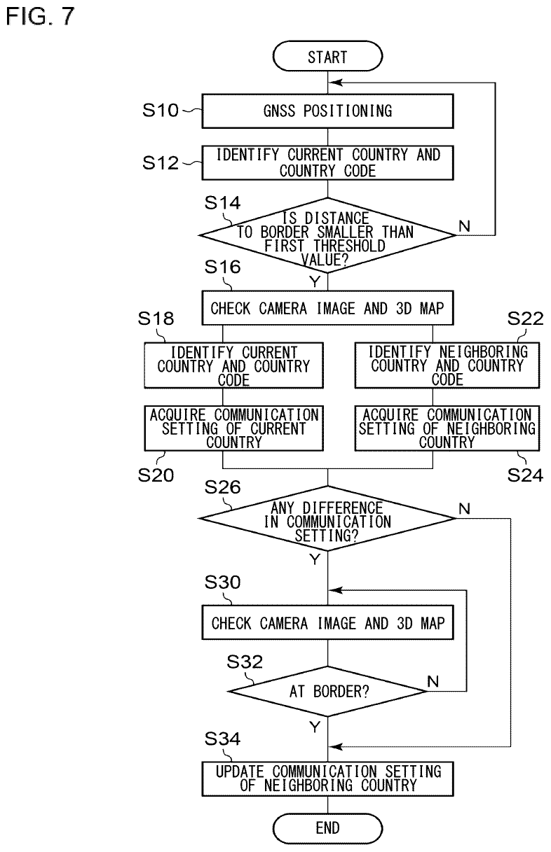

FIG. 7 is a flowchart showing a second exemplary process performed by the vehicle-mounted apparatus 100 of FIG. 1. The process of FIG. 7 is performed repeatedly. The processes of S10 to S26 are the same as those of the first exemplary process of FIG. 5. When there is no difference between the two communication settings in S26 (N in S26), the process of S34 identical to that of the first exemplary process is executed, and the process is terminated. When there is a difference between the two communication settings in S26 (Y in S26), the process of S30 is executed. The processes of S30, S32, and S34 are the same as those of the first exemplary process.

According to the embodiment, the communication unit 10 is caused to use the communication setting of the second country in the event that the first position information reaches a distance from the border smaller than the first threshold value provided that the relationship between the second position information derived based on the image data in front of the vehicle 1 and the border meets a predetermined criterion. Therefore, even if it is difficult to receive a signal from the GNSS satellite and the accuracy of the first position information may be low as the vehicle passes the border, the communication setting can be switched at a proper position based on the more accurate second position information. Thus, it is possible to suppress execution of communication in the first country or the second country in the frequency channel that cannot be used. Further, the second position information does not need to be derived until the first position information reaches a distance from the border smaller than the first threshold value so that the processing load can be reduced.

Therefore, the possibility that the user is regarded as having violated the radio regulation can be reduced. Further, the available frequency channel is not restricted so that a decrease in user convenience can be suppressed.

In the basic configuration described above, the

camera image and the 3D map are checked by the vehicle-mounted apparatus 100, but the checking may be executed on the server as described below. The difference from the basic configuration will be mainly described below.

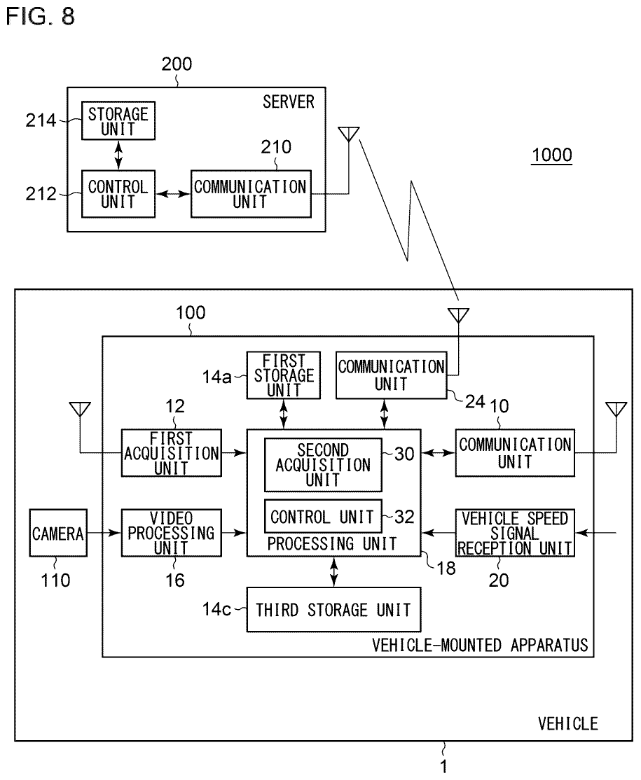

FIG. 8 shows another exemplary configuration of the wireless system 1000 of the embodiment. The wireless system 1000 further includes a server 200. The vehicle-mounted apparatus 100 includes a communication unit 24 instead of the second storage unit 14b. The communication unit 24 communicates wirelessly with the server 200. Wireless communication standard used is not particularly limited. For example, 4G (fourth-generation mobile communication system) or 5G (fifth-generation mobile communication system) may be used.

The process in the wireless system 1000 is performed according to the flowchart of FIG. 5 or FIG. 7. For example, the process of S16 of FIGS. 5 and 7, the process of identifying the current country of S18, and the process of identifying the neighboring country of S22 are executed by the server 200. Further, the processes of S30 and S32 of FIGS. 5 and 7 and the processes of S36 and S38 of FIGS. 5 are also executed by the server 200. The other processes are executed by the vehicle-mounted apparatus 100 as described above.

In the vehicle-mounted apparatus 100, the control unit 32 instructs the video processing unit 16 to start the process when the distance between the first position information and the border is smaller than the first threshold value (Y in S14 of FIGS. 5 and 7). The video processing unit 16 processes the image data in front of the vehicle 1 captured by the camera 110 in response to the instruction from the control unit 32 and supplies the processed image data to the processing unit 18. The control unit 32 transmits the image data received from the video processing unit 16 to the communication unit 24. The communication unit 24 transmits the image data received from the control unit 32 to the server 200.

The server 200 includes a communication unit 210, a control unit 212, and a storage unit 214. The communication unit 210 receives image data from the communication unit 24 of the vehicle-mounted apparatus 100 and transmits the received data to the control unit 212.

The storage unit 214 stores the aforementioned 3D map in the same manner as the second storage unit 14b. The control unit 212 derives the second position information and the orientation information on the vehicle 1 by checking the image data received from the communication unit 210 against the 3D map stored in the storage unit 214 in real time. This process corresponds to the process of S16 of FIGS. 5 and 7. The control unit 212 identifies the first country and the second country based on the second position information and the orientation information derived and supplies the information on the identified country to the communication unit 210. This process corresponds to a part of the process of S18 and a part of the process of S22 of FIGS. 5 and 7. The communication unit 210 transmits the information on the first country and the second country received to the vehicle-mounted apparatus 100 of the vehicle 1.

In the vehicle-mounted apparatus 100, the communication unit 24 receives the information on the first country and the second country from the server 200 and transmits the received information to the processing unit 18. The second acquisition unit 30 acquires the information on the first country and the second country transmitted from the communication unit 24 and supplies the acquired information to the control unit 32. Based on the information on the first country and the second country, the control unit 32 performs the process of S18 of FIGS. 5 and 7 for identifying the country code, the process of S22 for identifying the country code, and the subsequent processes.

When it is determined in S28 of FIG. 5 that the 5 GHz band is added in the communication setting of the neighboring country with respect to the communication setting of the current country (Y in S28), the control unit 32 causes the communication unit 24 to transmit, along with the image data, a first instruction to instruct the server 200 to confirm whether the second position information has reached the border. Transmission of the image data by the communication unit 24 is repeated at the frame rate of the camera 110.

When the communication unit 210 of the server 200 receives the image data and the first instruction, the control unit 212 derives the second position information on the vehicle 1 by checking the image data against the 3D map and determines whether the second position information indicates the border. When the second position information indicates the border, the control unit 212 causes the communication unit 210 to transmit information indicating that the second position information on the vehicle-mounted apparatus 100 indicates that the border has been reached. These processes correspond to the processes of S30 and S32 of FIG. 5.

In the vehicle-mounted apparatus 100, the control unit 32 that receives the information indicating that the second position information indicates that the border has been reached via the communication unit 24 executes the process of S34.

The processes of S32 through S34 executed when it is determined in S26 of FIG. 7 that there is a difference between the two communication settings (Y in S26) are similarly executed.

When it is determined in S28 of FIG. 5 that the 5 GHz band is not added (N in S28), on the other hand, the control unit 32 causes the communication unit 24 to transmit, along with the image data, a second instruction to instruct the server 200 to confirm whether the distance to the border is smaller than the second position information. Transmission of the image data by the communication unit 24 is repeated at the frame rate of the camera 110.

When the communication unit 210 of the server 200 receives the image data and the second instruction, the control unit 212 derives the second position information on the vehicle 1 by checking the image data against the 3D map and determines whether the distance to the border is smaller than the second threshold value. When the distance to the border is smaller than the second threshold value, the control unit 212 causes the communication unit 210 to transmit information directed to the vehicle-mounted apparatus 100 and indicating that the distance to the border is smaller than the second threshold value. These processes correspond to the processes of S36 and S38 of FIG. 5.

The control unit 32 of the vehicle-mounted apparatus 100 that receives the information indicating that the distance to the border is smaller than the second threshold value via the communication unit 24 executes the process of S34.

The 3D map has a relatively large amount of data. Also, the 3D map can be updated at a relatively high frequency to maintain accuracy. In the exemplary configuration of FIG. 8, the vehicle-mounted apparatus 100 does not need to communicate wirelessly to update the 3D map so that an increase in the amount of data in wireless communication of the vehicle-mounted apparatus 100 can be suppressed.

The present disclosure has been described above based on the embodiment. The embodiment is intended to be illustrative only and it will be understood by those skilled in the art that various modifications to combinations of constituting elements and processes are possible and that such modifications are also within the scope of the present disclosure.

In the embodiment, the second acquisition unit 30 or the control unit 212 derives the second position information, etc. based on the image captured by the camera 110 and the 3D map, but the derivation does not need to be executed in this way. For example, a LIDAR (Laser Imaging

Detection and Ranging) for capturing a distance image in front of the vehicle 1 may be used as the sensor mounted on the vehicle 1, and the second acquisition unit 30 or the control unit 212 may check the distance image acquired by the LIDAR against the 3D map in real time to derive the second position information, etc. on the vehicle 1. The distance image corresponds to the vehicle peripheral information. For derivation of the current position using LIDAR, a known technology can be used.

Further, a magnetic sensor may, for example, be used as the sensor mounted on the vehicle 1, and the magnetic sensor may detect the magnetic force of a magnetic marker installed on the road surface at regular intervals along the traveling route of the vehicle 1. The second acquisition unit 30 may derive the second position information and the orientation information on the vehicle 1 based on the detection result of the magnetic sensor. The magnetic force corresponds to the vehicle peripheral information. For derivation of the current position using a magnetic marker and a magnetic sensor, a publicly known technology can be used.

Alternatively, the magnetic sensor may detect the magnetic field from an electromagnetic induction line installed on the road surface along the traveling route of the vehicle 1. The second acquisition unit 30 may derive the second position information and the orientation information on the vehicle 1 based on the detection result of the magnetic sensor. The magnetic field corresponds to the vehicle peripheral information. For derivation of the current position using the electromagnetic induction line and the magnetic sensor, a publicly known technology can be used. According to these variations, the flexibility of the configuration of the wireless system 1000 can be improved.

In the embodiment, the second position information on the vehicle 1 is derived by checking the image data against the 3D map when the distance to the border is smaller than the first threshold value. In this process, the second position information may not be derived. Instead of using the second position information, the control unit 32 may identify the first country and the second country based on the first position information and the orientation information acquired by the first acquisition unit 12 and the map information stored in the first storage unit 14a, when the distance to the border is smaller than the first threshold value. According to this variation, the second position information does not need to be derived when the communication setting of the first country is the same as the communication setting of the second country, and so the processing load can be reduced.

One embodiment of the present disclosure is summarized below.

### Item 1

A vehicle-mounted apparatus mounted on a vehicle, including:
a communication unit that is adapted to communication in one of a plurality of frequency channels;
a storage unit that stores information on a communication setting of each of a plurality of areas, the communication setting of each area including information on the frequency channel adapted to be used by the communication unit in the area;
an acquisition unit that acquires first position information on the vehicle measured based on a signal from a GNSS satellite; and
a control unit that, in a case the first position information acquired by the acquisition unit changes from a first area to a second area, causes the communication unit to use the communication setting of the first area based on the information stored in the storage unit in an event that the first position information is distanced, in the first area, from a boundary between the first area and the second area by a predetermined threshold or larger,
wherein, in an event that the first position information reaches a distance to the boundary smaller than the threshold value, the control unit causes the communication unit to use the communication setting of the second area based on the information stored in the storage unit provided that a position relationship between i) second position information on the vehicle derived based on vehicle peripheral information acquired by a sensor mounted on the vehicle and ii) the boundary meets a predetermined criterion.

According to this embodiment, it is possible, even if the accuracy of the first position information is likely to be low in a situation of passing the boundary, to switch the communication setting at a proper position based on the more accurate second position information. Therefore, it is possible to suppress execution of communication in the first area or the second area in the frequency channel that cannot be used. Further, the second position information does not need to be derived until the first position information reaches a distance to the border smaller than the threshold value so that the processing load can be reduced.

### Item 2

The vehicle-mounted apparatus according to Item 1, wherein, in a case the communication setting of the first area is the same as the communication setting of the second area, the control unit causes the communication unit to use the communication setting of the second area regardless of the position relationship between the second position information and the boundary in an event that the first position information reaches a distance from the boundary smaller than the threshold value, and
wherein, in a case the communication setting of the first area is different from the communication setting of the second area, the control unit causes the communication unit to use the communication setting of the second area in an event that the first position information reaches a distance from the boundary smaller than the threshold value provided that the position relationship between the second position information and the boundary meets the predetermined criterion.

In this case, it is not necessary to identify the

position relationship between the second position information and the border when the communication setting of the first area is the same as the communication setting of the second area so that the processing load can be reduced.

### Item 3

The vehicle-mounted apparatus according to Item 1, wherein, in a case the communication setting of the first area is different from the communication setting of the second area, the control unit determines that the predetermined criterion is met and causes the communication unit to use the communication setting of the second area in an event that the first position information reaches a distance from the boundary smaller than the threshold value provided that the second position information reaches the boundary.

In this case, it is possible, in the case the frequency channel that cannot be used in the first area can be used in the second area, to reliably suppress execution of communication in that frequency channel in the first area. In the case the frequency channel that can be used in the first area cannot be used in the second area, it is possible to reliably suppress execution of communication in that frequency channel in the second area.

### Item 4

The vehicle-mounted apparatus according to Item 1 or 2, wherein, in a case the communication setting of the first area includes information on the frequency channel in the first frequency band and does not include information on the frequency channel in the second frequency band, and the communication setting of the second area includes information on the frequency channel in each of the first frequency band and the second frequency band, and the frequency channel in the first frequency band in the communication setting of the first area is the same as the frequency channel in the first frequency band in the communication setting of the second area, the control unit determines that the predetermined criterion is met and causes the communication unit to use the communication setting of the second area in an event that the second position information has reached or passed the boundary.

In this case, it is possible to reliably suppress execution of communication in the first area in the frequency channel in the second frequency band that cannot be used.

### Item 5

The vehicle-mounted apparatus according to Item 4, wherein, in a case the communication setting of the first area includes the frequency channel in each of the first frequency band and the second frequency band, the communication setting of the second area includes the frequency channel in the first frequency band and does not include the frequency channel in the second frequency band, and the frequency channel in the first frequency band in the communication setting of the first area is the same as the frequency channel in the first frequency band of the communication setting of the second area, the control unit determines that the predetermined criterion is met and causes the communication unit to use the communication setting of the second area in an event that the second position information reaches, in the first area, a distance from the boundary smaller than a further threshold value, and
wherein the further threshold value is smaller than the threshold value.

In this case, it is possible to reliably suppress execution of communication in the second area in the frequency channel in the second frequency band that cannot be used.

### Item 6

A control method in a vehicle-mounted apparatus mounted on a vehicle, the vehicle-mounted apparatus including a communication unit that is adapted to communication in one of a plurality of frequency channels, and a storage unit that stores information on a communication setting of each of a plurality of areas, the communication setting of each area including information on the frequency channel adapted to be used by the communication unit in the area, the method including:
acquiring first position information on the vehicle measured based on a signal from a GNSS satellite; and
in a case the first position information acquired by the acquiring changes from a first area to a second area, causing the communication unit to use the communication setting of the first area based on the information stored in the storage unit, when the first information is distanced, in the first area, from a boundary between the first area and the second area by a predetermined threshold or larger,
in an event that the first position information reaches a distance to the boundary smaller than the threshold value, causing the communication unit to use the communication setting of the second area based on the information stored in the storage unit provided that a position relationship between i) second position information on the vehicle derived based on vehicle peripheral information acquired by a sensor mounted on the vehicle and ii) the boundary meets a predetermined criterion.

According to this embodiment, it is possible to reliably suppress execution of communication in the first area or the second area in the frequency channel that cannot be used. In addition, the processing load can be reduced.

While various embodiments have been described herein above, it is to be appreciated that various changes in form and detail may be made without departing from the spirit and scope of the invention(s) presently or hereafter claimed.

### CROSS-REFERENCE TO RELATED APPLICATIONS

This application is based upon and claims the benefit of priority from the prior Japanese Patent Application No. 2024-044908, filed on Mar. 21, 2024, the entire contents of which are incorporated herein by reference.

What is claimed is:

1. A vehicle-mounted apparatus mounted on a vehicle, comprising:
a communication unit that is adapted to communication in one of a plurality of frequency channels;
a storage unit that stores information on a communication setting of each of a plurality of areas, the communication setting of each area including information on the frequency channel adapted to be used by the communication unit in the area;
an acquisition unit that acquires first position information on the vehicle measured based on a signal from a GNSS satellite; and
a control unit that, in a case the first position information acquired by the acquisition unit changes from a first area to a second area, causes the communication unit to use the communication setting of the first area based on the information stored in the storage unit in an event that the first position information is distanced, in the first area, from a boundary between the first area and the second area by a predetermined threshold or larger,
wherein, in an event that the first position information reaches a distance to the boundary smaller than the threshold value, the control unit causes the communication unit to use the communication setting of the second area based on the information stored in the storage unit provided that a position relationship between i) second position information on the vehicle derived based on vehicle peripheral information acquired by a sensor mounted on the vehicle and ii) the boundary meets a predetermined criterion.

2. The vehicle-mounted apparatus according to claim 1, wherein, in a case the communication setting of the first area is the same as the communication setting of the second area, the control unit causes the communication unit to use the communication setting of the second area regardless of the position relationship between the second position information and the boundary in an event that the first position information reaches a distance from the boundary smaller than the threshold value, and
wherein, in a case the communication setting of the first area is different from the communication setting of the second area, the control unit causes the communication unit to use the communication setting of the second area in an event that the first position information reaches a distance from the boundary smaller than the threshold value provided that the position relationship between the second position information and the boundary meets the predetermined criterion.

3. The vehicle-mounted apparatus according to claim 1, wherein, in a case the communication setting of the first area is different from the communication setting of the second area, the control unit determines that the predetermined criterion is met and causes the communication unit to use the communication setting of the second area in an event that the first position information reaches a distance from the boundary smaller than the threshold value provided that the second position information reaches the boundary.

4. The vehicle-mounted apparatus according to claim 1, wherein, in a case the communication setting of the first area includes information on the frequency channel in the first frequency band and does not include information on the frequency channel in the second frequency band, and the communication setting of the second area includes information on the frequency channel in each of the first frequency band and the second frequency band, and the frequency channel in the first frequency band in the communication setting of the first area is the same as the frequency channel in the first frequency band in the communication setting of the second area, the control unit determines that the predetermined criterion is met and causes the communication unit to use the communication setting of the second area in an event that the second position information has reached or passed the boundary.

5. The vehicle-mounted apparatus according to claim 4, wherein, in a case the communication setting of the first area includes the frequency channel in each of the first frequency band and the second frequency band, the communication setting of the second area includes the frequency channel in the first frequency band and does not include the frequency channel in the second frequency band, and the frequency channel in the first frequency band in the communication setting of the first area is the same as the frequency channel in the first frequency band of the communication setting of the second area, the control unit determines that the predetermined criterion is met and causes the communication unit to use the communication setting of the second area in an event that the second position information reaches, in the first area, a distance from the boundary smaller than a further threshold value, and wherein the further threshold value is smaller than the threshold value.

6. A control method in a vehicle-mounted apparatus mounted on a vehicle, the vehicle-mounted apparatus including a communication unit that is adapted to communication in one of a plurality of frequency channels, and a storage unit that stores information on a communication setting of each of a plurality of areas, the communication setting of each area including information on the frequency channel adapted to be used by the communication unit in the area, the method comprising:
acquiring first position information on the vehicle measured based on a signal from a GNSS satellite;
in a case the first position information acquired by the acquiring changes from a first area to a second area, causing the communication unit to use the communication setting of the first area based on the information stored in the storage unit, when the first position information is distanced, in the first area, from a boundary between the first area and the second area by a predetermined threshold or larger; and
in an event that the first position information reaches a distance to the boundary smaller than the threshold value, causing the communication unit to use the communication setting of the second area based on the information stored in the storage unit provided that a position relationship between i) second position information on the vehicle derived based on vehicle peripheral information acquired by a sensor mounted on the vehicle and ii) the boundary meets a predetermined criterion.
